(19) United States
(12) Patent Application Publication
(10) Pub. No.: US 2020/0062053 A1
(43) Pub. Date: Feb. 27, 2020

(54) APPARATUS AND METHOD FOR SEATING A TUBELESS TIRE

(71) Applicant: MARTINS INDUSTRIES INC., Farnham (CA)

(72) Inventors: Martin DÉPELTEAU, Farnham (CA); Ian FOURNEL-VÉZINA, Farnham (CA); Jonathan LANDRY, Farnham (CA)

(21) Appl. No.: 16/551,176

(22) Filed: Aug. 26, 2019

Related U.S. Application Data
(60) Provisional application No. 62/722,218, filed on Aug. 24, 2018.

(51) Int. Cl. B60C 25/14

(52) U.S. Cl. CPC B60C 25/145; B60C 25/147

(57) ABSTRACT

An apparatus for seating a tire and rim assembly comprising a tubeless tire on a rim and defining opposite lateral sides thereof. The apparatus comprising an enclosure and a bead-seater pivotally mounted thereto. The apparatus also comprises a bead-seater pivotally mountable to an enclosure. The enclosure defines an internal area thereof for enclosing a tire and rim assembly therein in a vertical position. The enclosure defining at least one entry opening for receiving the tire and rim assembly and at least one access opening. The bead-seater being selectively pivoted for operationally engaging the tire and rim at one lateral side thereof about a junction thereof via the access opening to seat the tire on the rim. A support member is positioned within the enclosure and extends within the inner area for supporting the tire and rim assembly thereon at an opposite lateral side thereof in the vertical position.

### CROSS-REFERENCE TO RELATED APPLICATIONS

The present application claims priority on U.S. Provisional Patent Application No. 62/722,218 filed on Aug. 24, 2018 and incorporated herein by reference in its entirety.

### TECHNICAL FIELD

The present disclosure generally relates tubeless tires. More particularly but not exclusively the present disclosure relates to an apparatus and method for seating a tubeless tire.

### BACKGROUND

Unlike pneumatic tires which use a separate inner tube, tubeless tires have continuous ribs molded integrally into the bead of the tire so that they are forced by the pressure of the air inside the tire to seal with the flanges of the metal rim of the wheel. The tire bead is the term for the edge of a tire that sits on the wheel. The bead is an important component of tire construction, helping it to stand and support weight. The rim has a slot or groove defining the flanges. When the tire is properly inflated the air pressure within the tire keeps the bead in this groove. The tire bead is held in this groove by air pressure. This is referred to as seating the tire, the tire is properly positioned on the rim with the bead of the tire snuggly engaging the flanges of the rim by of air pressure.

Inflating and seating tubeless tires is a burdensome process that poses several dangers. The tire is mounted on the rim and laid flat on the floor, sometimes a small support is used to space the rim and tire slight from the floor (e.g. a couple of side by side two-by-fours on a plank). The user will then inflate the tire about the rim. At a given air pressure level, the user will use a bead seater tool which includes a tank and nozzle to blast air pressure between at the junction of the tire bead with the rim flange there seating the bead within the groove so that it properly engages the inner side of the flange. The user will continue to add air pressure. The user may stop adding pressure to place the tire vertically to add the remaining air pressure. The foregoing steps are time consuming and may cause injury to the worker as the tire needs to be rolled, laid flat. The worker needs to bend down to connect the air tube to the tire. The worker also needs to bend down near the inflating tire during blasting with the heavy bead seater tool. The worker needs to lift the tire vertically and position it for additional inflation, thereby needing to remove the air tube in order to add another air tube and finally the tire is rolled out to be mounted to the object vehicle. The foregoing steps can cause fatigue as the worker is freely handling high-pressure tools such as the bead seater. Improper seating may also be life threatening as the blast may backfire. Overinflating the tire can also cause the tire to explode thereby potentially gravely injuring the worker. In some cases, the user should stop inflating the tire and the blast the rim and tire junction for seating with the bead seating tool and then restart inflating as blasting during inflating may also cause blowback which can be dangerous.

### Objects

An object of the present disclosure is to provide an apparatus for seating a tubeless tire.

An object of the present disclosure is to provide a method for seating a tubeless tire.

### SUMMARY

In accordance with an aspect of the present disclosure, there is provided an apparatus for seating a tire and rim assembly comprising a tubeless tire on a rim and defining opposite lateral sides thereof, the apparatus comprising: an enclosure defining an internal area thereof for enclosing a tire and rim assembly therein in a vertical position, the enclosure defining at least one entry opening for receiving the tire and rim assembly and at least one access opening; and a bead-seater pivotally mounted to the enclosure for being selectively pivoted for operationally engaging the tire and rim at one lateral side thereof about a junction thereof via the access opening to seat the tire on the rim. In an embodiment, a support member is positioned within the enclosure and extending within the inner area for supporting the tire and rim assembly thereon at an opposite lateral side thereof in the vertical position.

In an embodiment, the apparatus further comprises a control unit in communication with an air pressure source and with the bead-seater for providing air pressure thereto. In an embodiment, the control unit is mounted to the enclosure adjacent the bead seater. In an embodiment, the control unit further comprises a conduit for being positioned in fluid communication with the tire for inflating the tire with air pressure.

In an embodiment, the bead-seater comprises a nozzle inwardly angled so as to extend towards the enclosure when in a first position away from the junction of the tire and rim for movement to a second position towards the junction of the tire and the rim for operational engagement therewith during pivoting of the bead-seater.

In an embodiment, the apparatus further comprises a support frame mounted to the enclosure, the bead seater comprising a tank and a nozzle extending therefrom, the tank being pivotally connected to the support frame for selective pivoting thereof providing the nozzle to move between first position away from the junction of the tire and rim for movement to a second position towards the junction of the tire and the rim for operational engagement therewith. In an embodiment, the tank comprises a radially extending lever for allowing a user to impart the pivoting movement thereto. In an embodiment, the support frame comprises a center portion and lateral wings extending therefrom, the tank being pivotally mounted to the center portion. In an embodiment, the apparatus further comprises a control unit in communication with an air pressure source and with the bead-seater for providing air pressure thereto, the control unit being mounted to one of the latera wings. In an embodiment, the nozzle is inwardly angled so as to extend towards the enclosure when in the first position.

In accordance with aspect of the disclosure, there is provided an apparatus for seating a tire and rim assembly within an enclosure, the tire and rim assembly comprising a tubeless tire on a rim and defining opposite lateral sides thereof, the enclosure defining an internal area thereof for enclosing the tire and rim assembly therein in a vertical position, the enclosure defining at least one entry opening for receiving the tire and rim assembly and at least one access opening; the apparatus comprising: a support frame for being mounted to the enclosure, a bead-seater pivotally mounted to the support frame, for being selectively pivoted for operationally engaging the tire and rim at one lateral side thereof about a junction thereof via the access opening to seat the tire on the rim.

In an embodiment of this aspect of the disclosure, the bead seater comprises a tank and a nozzle extending therefrom, the tank being pivotally connected to the support frame for selective pivoting thereof providing the nozzle to move between first position away from the junction of the tire and rim for movement to a second position towards the junction of the tire and the rim for operational engagement therewith.

In an embodiment of this aspect of the disclosure, the tank comprises a radially extending lever for allowing a user to impart the pivoting movement thereto.

In an embodiment of this aspect of the disclosure, the support frame comprises a center portion and lateral wings extending therefrom, the tank being pivotally mounted to the center portion. In an embodiment of this aspect of the disclosure, the apparatus further comprises a control unit in communication with an air pressure source and with the bead-seater for providing air pressure thereto, the control unit being mounted to one of the lateral wings.

In an embodiment of any aspect of the disclosure, the apparatus further comprises a dampener for dampening the pivot movement towards the junction.

In an embodiment of any aspect of the disclosure, the enclosure comprises a platform with rollers for rolling receiving the tire thereon.

In an embodiment of any aspect of the disclosure, the apparatus further comprises a support member positioned within the enclosure and extending within the inner area for supporting the tire and rim assembly thereon at an opposite lateral side thereof in the vertical position. In an embodiment of any aspect of the disclosure, the support member comprises an impact face for receiving the tire and rim assembly thereon and lateral inwardly angled walls.

In accordance with aspect of the present disclosure, there is provided a method for seating a tire and rim assembly comprising a tubeless tire on a rim and defining opposite lateral sides thereof, the method comprising: positioning the tire and rim assembly in the vertical position; enclosing the tire and rim assembly within an enclosure defining access openings; pivotally mounting a bead-seater on a fixed structure to pivotally engage one side of the tire and rim assembly about a junction thereof via the access opening; seating the tire to the rim by operationally engaging the bead-seater with the junction providing a support at the other side of the tire and rim assembly during seating to maintain the tire and rim assembly in the vertical position.

Other objects, advantages and features of the present disclosure will become more apparent upon reading of the following non-restrictive description of illustrative embodiments thereof, given by way of example only with reference to the accompanying drawings.

### BRIEF DESCRIPTION OF THE DRAWINGS

In the appended drawings:

FIG. 1 is a front and lateral side perspective view of the apparatus for seating a tubeless tire in accordance with a non-restrictive illustrative embodiment of the present disclosure;

FIG. 2 is a front and other lateral side perspective view of the apparatus for seating a tubeless tire in accordance with a non-restrictive illustrative embodiment of the present disclosure;

FIG. 3 is a front view of the apparatus for seating a tubeless tire in accordance with a non-restrictive illustrative embodiment of the present disclosure;

FIG. 4 is a lateral view of the apparatus for seating a tubeless tire in accordance with a non-restrictive illustrative embodiment of the present disclosure;

FIG. 5A is a perspective rear view of the bead-seater of the apparatus of FIGS. 1 to 4 in accordance with a non-restrictive illustrative embodiment of the present disclosure;

FIG. 5B is a lateral view of the bead-seater of FIG. 5A;

FIG. 5C is a sectional view of FIG. 5A taken along line 5C-5C thereof as well as a sectional view of FIG. 5D taken along line B-B thereof;

FIG. 5D is rear view of the bead seater of FIG. 5;

FIG. 5E is a front view of the bead seater of FIG. 5;

FIG. 5F is a side view of the tank of the bead seater of FIG. 5;

FIG. 6 is a front and lateral side perspective view of the apparatus of FIGS. 1 to 4, with a tire and rim assembly therein;

FIG. 7 is a front view of the apparatus as shown in Figure with the tire and rim assembly being shown in a sectional view;

FIGS. 8A, 8B and 8C are photos of the top of the apparatus of FIGS. 1 to 4, showing the seating operation;

FIG. 9 is a broken perspective view of the tire and rim assembly schematically illustrating engagement of the bead-seater of FIG. 5A.

It is understood that the drawings form part of the disclosure.

### DETAILED DESCRIPTION OF ILLUSTRATIVE EMBODIMENTS

Generally stated and in accordance with an aspect of the present disclosure, there is provided an apparatus for seating a tire and rim assembly comprising a tubeless tire on a rim and defining opposite lateral sides thereof. The apparatus comprising an enclosure and a bead-seater pivotally mounted thereto. The apparatus also comprises a bead-seater pivotally mountable to an enclosure. The enclosure defines an internal area thereof for enclosing a tire and rim assembly therein in a vertical position. The enclosure defining at least one entry opening for receiving the tire and rim assembly and at least one access opening. The bead-seater being selectively pivoted for operationally engaging the tire and rim at one lateral side thereof about a junction thereof via the access opening to seat the tire on the rim. A support member is positioned within the enclosure and extends within the inner area for supporting the tire and rim assembly thereon at an opposite lateral side thereof in the vertical position.

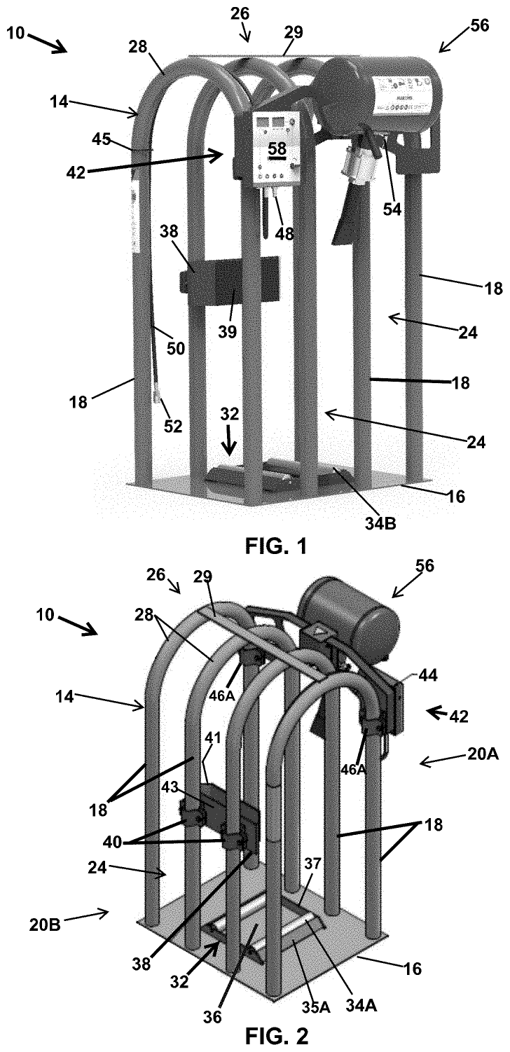

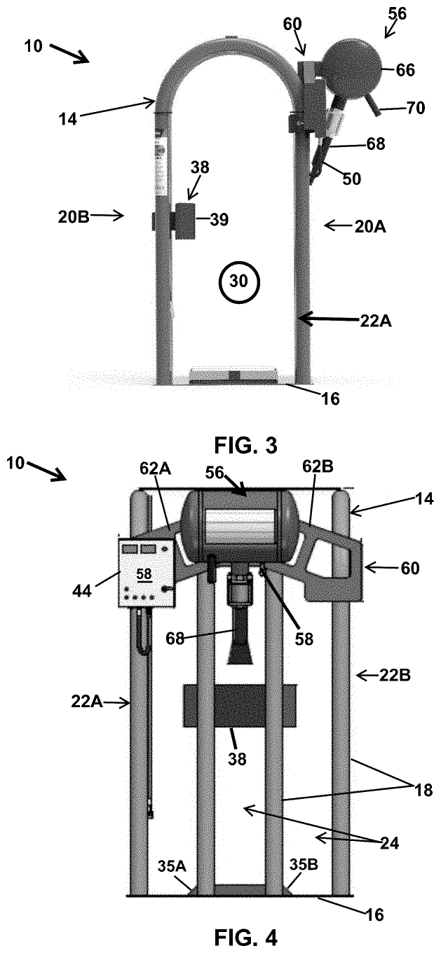

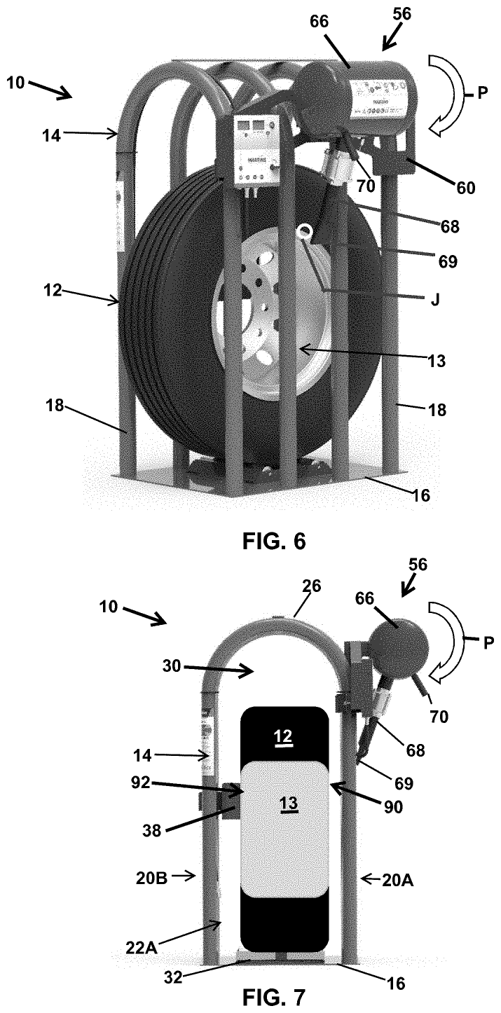

With reference to FIGS. 1 to 4, there is shown an apparatus 10 for seating tubeless tires 12 mounted to a rim 13 as shown in FIGS. 6,7 and 9.

The apparatus 10 comprises an enclosure 14 including a platform 16 having spaced apart cage bars 18 upstanding therefrom along the lateral sides 20A and 20B of the enclosure 14 and defining front and rear faces 22A and 22B respectively. As shown both front and rear faces, 22A and 22B are open and define a respective entry opening for the tire 12 and rim 13 assembly. It is to be understood that the terms ‘front’ and ‘rear’ are interchangeable and are only used herein for indicative purposes. In an embodiment, only one of the faces 22A and 22B may be open. In an embodiment, closure doors (not shown) may also be used to selectively close and open either one of the faces 22A and 22B.

The configuration of the enclosure 14 provides lateral access opening 24 at each lateral side 20A and 20B. In this example, the lateral openings 24 are formed by the spaces between the cage bars 18. The bars 18 define the top part 26 of the enclosure 14. In this example, bars 18 on side 20A are co-aligned bars 18 on side 20B and meet up (at top part 26) by curved extension portions 28 defining the dome like configuration of the top part 26. A flat member 29 sits on top of the extension portions 28 to provide structural support to the cage 14 and maintain the bars 18 in place along with platform 16.

As such, enclosure 14 is a cage with flat platform 16, bars 18 on each lateral side 20A and 20B meeting at the top part 26 via curved extension 28 and open front and rear faces 22A and 22B. The enclosure cage 14 thus defines the tire receiving area 30 therein.

The platform 16 includes a tire roller 32 for providing the tire 12 to roll into and out of the cage 14 so as to be positioned within the area 30 and removed therefrom. The tire roller includes a pair of longitudinal rollers 34A and 34B spanning the width of a tire rolling thereon and forming a groove 36 therebetween for keeping the tire 12 in place during inflating and seating as will be further described herein. Short ramps 35A, 35B are adjacent to rollers 34A and 34B for rolling a tire onto or off of a roller. The short ramps 35 and 35B are connected to at their ends to side support members 37 which also rollingly receive the ends of rollers 34A and 34B. Of course, other types of rollers to facilitate tire movement in and out of the cage 14 can be contemplated by the skilled artisan within the scope of the present disclosure.

The enclosure cage 14 includes a lateral tire support element 38 mounted to the bars 18 at lateral side 20B. The support element 38 is in the form of backing plate extending into area 30 with rear clamps 40 clamped to bars 18. The backing plate 38 includes an impact face 39 comprising a resilient and flexible material for not damaging the rim 13 of the tire 12 (see FIGS. 6, 7 and 9). With particular reference to FIGS. 1 and 2, the impact face 39 protrudes into area 30 via inwardly projecting side walls 41 extending from the rear wall 43 of the backing plate 38. The inwardly projecting side walls 41 also provide for leading the tire in position onto the tire roller 32. When a tire is rolled into the cage 14 it may tend to wobble, the inwardly slanted wall 41 it encounters will provide it to roll towards and onto the roller 32 and the support 30 will allow the tire to lean thereon in position for both inflating and blasting as will be further discussed herein.

A control unit 42 is mounted to lateral side 20A of the enclosure cage 14. The control unit 42 includes a panel 44 mounted to a bar 18 via a rear clamp 46A. The panel 44 includes an inlet 48 for being connected to an air pressure tank (not shown but known in the art). A conduit in the form of an air hose 50 extends from the panel 44 along the extension portion 28 of the bar 18 that the panel 44 is mounted to. From this position at the top 26 of the extension portion 28, the hose extends downwardly along a co-aligned bar 18 on side 20B (where it is attached thereto via an attachment 45 such as tie-wrap) towards the platform 16. The hose 50 includes an open air chuck 52 for being connected to the tire 12 during inflating thereof. As such, the chuck 52 is provided to be easily mounted to the tire for inflating as it is in a convenient position with enough free slack (from its attachment 45) to allow the user to conveniently secure it to the tire for inflation.

A conduit 54 extends from the panel 44 to a bead-seater 56 which will be discussed further below.

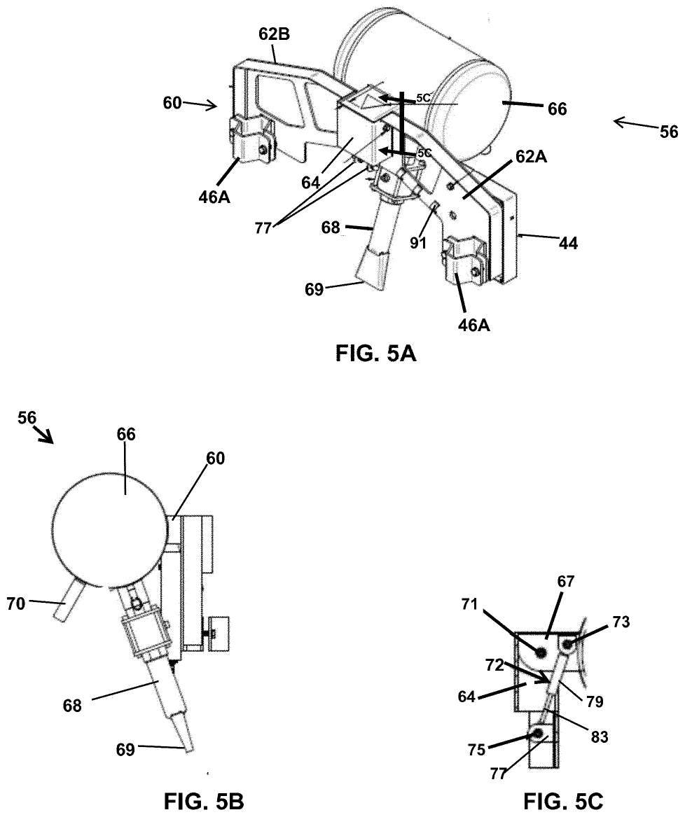

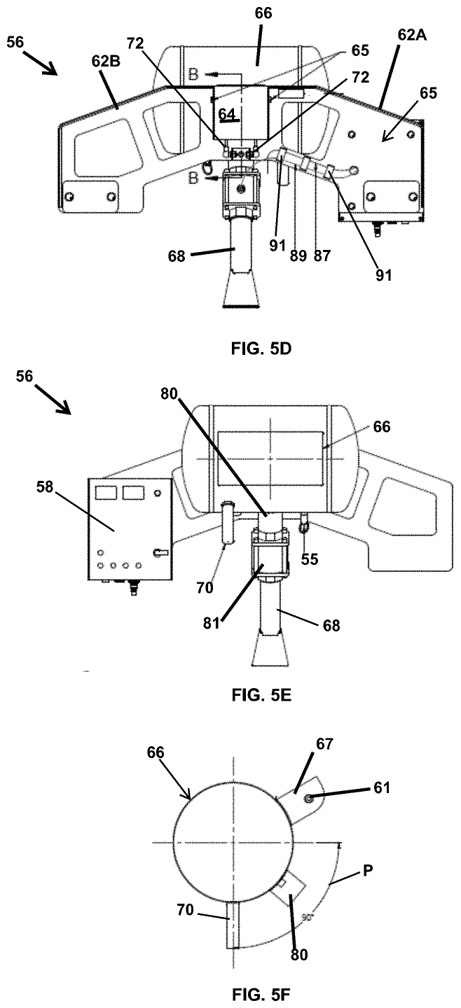

The panel 44 includes a user interface board 58 for allowing the user to selectively control air pressure flowing from the air pressure source tank (not shown) to the tire 12, via hose 50 during the inflating and to control air pressure flowing to the bead-seater 56 via hose 54 connected to a safety valve 55 (shown in FIG. 5E).

The panel 44 and the bead-seater 56 are both mounted to a support frame 60. Support frame 60 includes lateral wing members 62A and 62B, each wing member 62A and 62B including a respective rear clamp 46A and 46B for clamping a respective bar 18 on lateral side 20A of the enclosure cage 14. The panel 44 is mounted to lateral wing member 62A.

With reference to FIGS. 1 to 4 and FIGS. 5A to 5F, the air bead seating tool (i.e. bead seater 56) will now be described in accordance with a non-restrictive illustrative embodiment of the present disclosure.

Bead-seater 56 is mounted to the center portion 64 of the support frame 60 interposed between the wings 62A and 62B, which downwardly extend from the center portion 64. The bead-seater 56 includes a tank 66 connected to the conduit 54 which is connected to the control panel 44 for selectively receiving air pressure from the source tank (not shown but known in the art). The tank 66 provides for storing a sufficient amount of pressurized air which is blasted out via the nozzle 68 downwardly and radially extending from the tank 66 and connected thereto via tank inlet tube 80 and connector 82 (see FIGS. 5E and 5F). The nozzle 68 extends in a diagonal fashion with the free nozzle end 69 thereof pointing towards the direction of area 30 and being positioned to interface with an opening 24 between a pair of bars 18.

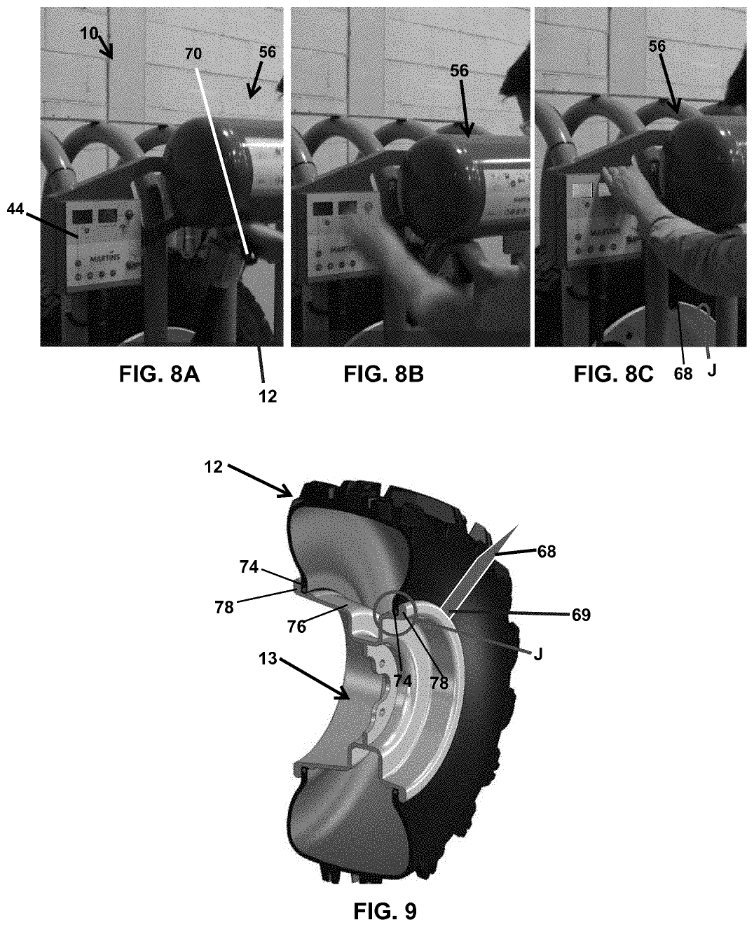

The user interface board 58 provides for the user to selectively blast air from the tank 66. The user interface board 58 is thus fixedly positioned neat the fixed but movable position of the bead seater 56 providing an ergonomic and safe arrangement for the user. The interface board 58 and the bead seater is thus laid out in front of the user near eye level range as shown in FIGS. 8A to 8C. The user can thus enter commands via the interface board 58 and pivot the bead seater 56 from the same standing position as will be further discussed.

A lever 70 radially extends from tank 66 allowing the user to pivot the tool 56 about the pivot defined by the center portion 64 and as shown by the arrows P in FIGS. 6 and 7 during the seating step where air is blasted at the junction J (see FIGS. 6 and 9) of the rim and bead as will be further described below. Turning to FIG. 5C, the tank is pivotally connected to the center portion 64 via a pivot connection 71 dampened by a dampener such as a gas spring arrangement 72 in order to provide smooth pivot movement P. A biasing element such a spring or a flexible and/or resilient element, may also be used to dampen the inward pivot movement towards junction J and to allow for a biasing force away from the junction J when manipulated by the user.

The center portion 64 defines an inwardly rectangular body for receiving pivots 65 pivotally connected to a connector 67 extending from the tank of the bead seater 56 as shown in FIGS. 5D and 5F. The connector 67 includes a pivot connecting element 61 which together with pivots 65 (e.g. pivot rods, washers, nylon lock nuts etc.) define the pivot axis 71 of pivot movement P. The gas spring arrangement 72 is anchored at its top end 73 to the connector 67 and at its bottom end 75 to a tab 77 beneath the center portion 64. The gas spring arrangement 72 includes a piston 79 and rod 83. As better shown in FIG. 5D, a double gas spring arrangement 72 (i.e. a pair or side by side piston 79 and rods 83) is provided. Of course, the skilled artisan an contemplate other pivotal connections of the bead-seater 56 to the enclosure 14 for allowing the nozzle 68 to selectively move inwardly so for the free end 69 of the nozzle 68 is brought in close proximity to the junction J of the rim flanges and bead (as further described below) in order to blast air pressure thereto (as is known in the art) during seating.

With reference to FIG. 5D, the rear side 85 of wing 62A includes a soft tubing 87 for the tank fill and a soft tubing 89 for the release trigger both of which are fastened to the rear side 85 via clips 91.

With reference to FIGS. 6 to 9, the apparatus 10 will now be further described in operation.

As shown in FIGS. 6 and 7, the tubeless tire 12 is mounted onto the rim 13 and rolled into the area 30 defined by the enclosure cage 14 via open face 22A or 22B. The tire 12 rolls onto rollers 34A and 34B upstanding therefrom and partially settles within the groove 36 therebetween. The tire 12 slightly leans towards lateral side 20B and the rim 13 rests on the backing plate 38. As such, one side 90 (see FIG. 7) of the tire (12) and rim (13) assembly is engaged by the bead-seater 56 and the other side 92 (see FIG. 7) slightly leans towards the lateral side 20B for engagement with the backing plate 38. In this way the weight of the tire 12 is on the roller 32 and backing plate 38 providing for the tire 12 with the rim 13 to be in a vertical position with a slight bias towards side 20B thereby engaging the backing plate 38 with the force of its own collective weight. The rim 13 engages plate 38. The user connects the air hose 50 to the tire 12 via the open air chuck and rim 13. The user inflates the upstanding tire 12 on the upstanding rim by controlling air flow thereto from the source tank via the control unit 42 as previously explained.

At a desired inflated level, the user will seat the bead of the tire on the rim via the bead-seater 56. For this operation, the user may selectively stop inflating the tire 12 via the control unit 42.

As shown in FIG. 9, the tubeless tire 12 includes a bead 74 which is positioned within the groove 76 of the rim 13 formed between the flanges 78. The bead 74 at each side of the tire 12 engages the inner side of each flange 78. The user moves the nozzle 68 and more specifically the nozzle end 69 to the junction J of the bead 74 and the flange as shown in FIG. 9 and blasts air pressure thereto to seat the bead 74 of the tire within the groove 76 and against the flanges 78 of the rim 13. The foregoing is accomplished by the user imparting a pivot movement to the bead-seater 56 as shown by arrows P in FIGS. 6 and 7 and as shown in FIGS. 8A, 8B and 8C. The user only needs to push the lever 70 downwards, as the configuration and position of the roller 32, the backing plate 38 and the angular positioning of the nozzle 58 provide for engaging the junction J with one simple downward push thereto all the while the worker can support themselves on the cage 14 and visualize the interface module 58 in tandem thereby providing, safety, ergonomic comfort and efficiency during the operation. The bead seater 56 is in a first position such as in FIG. 8A when it is not engaged, positioned away from junction J, yet the nozzle 68 is angled towards the enclosure pointing in the direction of junction J. The bead seater is in a second position when it engages the junction J such as in FIG. 8C.

Apparatus 10 allows the user to inflate the tire without laying it on the floor and having to pick it up again. The worker does not need to bend down to connect the air hose to the tire and the does not need to walk towards the source tank to shut it off in order to execute the seating step. The rim/tire assembly is always in the vertical position, eliminating the need to pick and drop the assembly on the ground. This also protects the rim from getting scratched.

During seating, the worker does not need to pick up the bead seating tool and bend down to blast air. The weight of the bead-seater and kick-back force when blasting is on the enclosure thereby reducing worker fatigue and risk of injury. The nozzle of the bead seater can be selectively adjusted in length and angle to account for tires and rims of variable diameters. The bead seater nozzle retracts automatically outside the protective enclosure cage, preventing it from being a projectile in the case of an explosion.

All operations are performed with the tire inside the protective enclosure cage thereby increasing safety. The rim/tire assembly is simply rolled in and out of the cage.

Tire inflating and tire seating operations are controlled via the same control unit which is on the cage next to the bead seater tool thereby providing the worker with easier handling. The worker simply stands at face 20A for the inflating and seating operations. Moreover, the air inlet from the source tank is the same for both tire seating and inflating operations.

The pivotable bead seater tool and control assembly with conduit for inflating a tire and backing plate can be installed on different cage models and can be retro-fitted on approved pre-purchased cages.

The apparatus 10 and components thereof can be provided in kits.

The various features described herein can be combined in a variety of ways within the context of the present disclosure so as to provide still other embodiments. As such, the embodiments are not mutually exclusive. Moreover, the embodiments discussed herein need not include all of the features and elements illustrated and/or described and thus partial combinations of features can also be contemplated. Furthermore, embodiments with less features than those described can also be contemplated. It is to be understood that the present disclosure is not limited in its application to the details of construction and parts illustrated in the accompanying drawings and described hereinabove. The disclosure is capable of other embodiments and of being practiced in various ways. It is also to be understood that the phraseology or terminology used herein is for the purpose of description and not limitation. Hence, although the present disclosure has been provided hereinabove by way of non-restrictive illustrative embodiments thereof, it can be modified, without departing from the scope, spirit and nature thereof and of the appended claims.

1. An apparatus for seating a tire and rim assembly comprising a tubeless tire on a rim and defining opposite lateral sides thereof, the apparatus comprising:
an enclosure defining an internal area thereof for enclosing a tire and rim assembly therein in a vertical position, the enclosure defining at least one entry opening for receiving the tire and rim assembly and at least one access opening; and
a bead-seater pivotally mounted to the enclosure for being selectively pivoted for operationally engaging the tire and rim at one lateral side thereof about a junction thereof via the access opening to seat the tire on the rim.

2. An apparatus according to claim 1, further comprising a control unit in communication with an air pressure source and with the bead-seater for providing air pressure thereto.

3. An apparatus according to claim 2, wherein the control unit is mounted to the enclosure adjacent the bead seater.

4. An apparatus according to claim 2, wherein the control unit further comprises a conduit for being positioned in fluid communication with the tire for inflating the tire with air pressure.

5. An apparatus according to claim 1, wherein the bead-seater comprises a nozzle inwardly angled so as to extend towards the enclosure when in a first position away from the junction of the tire and rim for movement to a second position towards the junction of the tire and the rim for operational engagement therewith during pivoting of the bead-seater.

6. An apparatus according to claim 1, further comprising a support frame mounted to the enclosure, the bead seater comprising a tank and a nozzle extending therefrom, the tank being pivotally connected to the support frame for selective pivoting thereof providing the nozzle to move between first position away from the junction of the tire and rim for movement to a second position towards the junction of the tire and the rim for operational engagement therewith.

7. An apparatus according to claim 6, wherein the tank comprises a radially extending lever for allowing a user to impart the pivoting movement thereto.

8. An apparatus according to claim 6, wherein the support frame comprises a center portion and lateral wings extending therefrom, the tank being pivotally mounted to the center portion.

9. An apparatus according to claim 8, further comprising a control unit in communication with an air pressure source and with the bead-seater for providing air pressure thereto, the control unit being mounted to one of the latera wings.

10. An apparatus according to claim 6, wherein the nozzle is inwardly angled so as to extend towards the enclosure when in the first position.

11. An apparatus according to claim 1, further comprising a dampener for dampening the pivot movement towards the junction.

12. An apparatus according to claim 1, wherein the enclosure comprises a platform with rollers for rolling receiving the tire thereon.

13. An apparatus according to claim 1, further comprising a support member positioned within the enclosure and extending within the inner area for supporting the tire and rim assembly thereon at an opposite lateral side thereof in the vertical position.

14. An apparatus according to claim 13, wherein the support member comprises an impact face for receiving the tire and rim assembly thereon and lateral inwardly angled walls.

15. An apparatus for seating a tire and rim assembly within an enclosure, the tire and rim assembly comprising a tubeless tire on a rim and defining opposite lateral sides thereof, the enclosure defining an internal area thereof for enclosing the tire and rim assembly therein in a vertical position, the enclosure defining at least one entry opening for receiving the tire and rim assembly and at least one access opening; the apparatus comprising:
a support frame for being mounted to the enclosure,
a bead-seater pivotally mounted to the support frame, for being selectively pivoted for operationally engaging the tire and rim at one lateral side thereof about a junction thereof via the access opening to seat the tire on the rim.

16. An apparatus according to claim 15, wherein the bead seater comprises a tank and a nozzle extending therefrom, the tank being pivotally connected to the support frame for selective pivoting thereof providing the nozzle to move between first position away from the junction of the tire and rim for movement to a second position towards the junction of the tire and the rim for operational engagement therewith.

17. An apparatus according to claim 16, wherein the tank comprises a radially extending lever for allowing a user to impart the pivoting movement thereto.

18. An apparatus according to claim 16, wherein the support frame comprises a center portion and lateral wings extending therefrom, the tank being pivotally mounted to the center portion.

19. An apparatus according to claim 18, further comprising a control unit in communication with an air pressure source and with the bead-seater for providing air pressure thereto, the control unit being mounted to one of the lateral wings.

20. A method for seating a tire and rim assembly comprising a tubeless tire on a rim and defining opposite lateral sides thereof, the method comprising:
positioning the tire and rim assembly in the vertical position;
enclosing the tire and rim assembly within an enclosure defining access openings;
pivotally mounting a bead-seater on a fixed structure to pivotally engage one side of the tire and rim assembly about a junction thereof via the access opening;
seating the tire to the rim by operationally engaging the bead-seater with the junction
providing a support at the other side of the tire and rim assembly during seating to maintain the tire and rim assembly in the vertical position.
